(19) United States
(12) Patent Application Publication
(10) Pub. No.: US 2009/0256805 A1
(43) Pub. Date: Oct. 15, 2009

(54) KEYBOARD WITH A PROJECTION

(75) Inventors: Gerhard Hochgesang, Bad Neustadt/Saale (DE); Klaus Schmoeger, Bad Neustadt/ (DE)

Correspondence Address: Muncy, Geissler, Olds & Lowe, PLLC, P.O. BOX 1364, FAIRFAX, VA, 22038-1364, US

(73) Assignee: Preh KeyTec GmbH

(21) Appl. No.: 12/424,343

(22) Filed: Apr. 15, 2009

(30) Foreign Application Priority Data
Apr. 15, 2008 (DE) DE102008019014.4
Jul. 4, 2008 (DE) DE102008031687.3

(51) Int. Cl. G06F 3/02

(52) U.S. Cl. 345/168

(57) ABSTRACT

A keyboard is provided as a peripheral device for a computer unit with a key field and an associated housing, whereby an extension is attached to the housing. The keyboard includes at least one reading device being accommodated in the extension for the contactless reading of data stored on ID cards or access cards or documents.

This nonprovisional application claims priority under 35 U.S.C. § 119(a) to German Patent Application No. DE 10 2008 019 014.4, which was filed in Germany on Apr. 15, 2008, and to German Patent Application No. DE 10 2008 031 687.3, which was filed in Germany on Jul. 4, 2008, and which are both herein incorporated by reference.

### BACKGROUND OF THE INVENTION

1. Field of the Invention

The invention relates to a keyboard as a peripheral device for a computer unit, as is typically used for data input into a computer unit, such as a PC. Therefore, this refers to an operating element, which has a number of keys to be pressed by the fingers, said keys being arranged in a key field. The keys are generally the electromechanical key contact switches. Prior-art PC keyboards comprise the numerical and or the alpha and/or the alphanumeric key field, typically 14 to 105 keys, depending on the desired special functions, more or fewer keys can be provided. The assignment of a key to the symbol generated therewith (“scan code”) follows from the keyboard layout. For a German keyboard, this is specified in the DIN standard 2137.

2. Description of the Background Art

A keyboard is generally preferred for rapid and efficient data input. Because apart from manual data input, additional inputs are often necessary, additional peripheral devices are usually connected to the computer unit, for example, optical scanners, such as barcode readers. For a high integration density, it is generally desirable to combine these peripheral devices. A separate arrangement has an enormous space requirement; the cabling interferes greatly and is interference-prone. Moreover, it has turned out that precisely during reading out of ID cards or access cards there is a need for a solution in which placement of the card in the vicinity of the keyboard is possible. On the one hand, it is routinely necessary in the case of said cards that in addition to the automatic, optical, or radio-controlled reading of the data stored on the card, additional acquisition of data is necessary that are printed on the card and are to be input by means of the keyboard. For this reason, placement near the keyboard is not only desirable but also necessary to facilitate the reading of the data, because a verbal inquiry for data from the card holder and a distant laying down of the particular card are of concern for data protection considerations.

European Pat. No. EP 1 070 299 B1, which corresponds to U.S. Pat. Nos. 6,750,777 and 6,542,070, discloses a terminal for libraries and the like. The self-service library terminal has a housing, which forms a cradle as a first circulating item receiving area. The cradle is arranged so that it takes up a circulating item, for example, a book, a magazine, a CD, or the like. A card holder is used to hold the patron's library card. A reader is supported on the housing and arranged so that it can read, for example, barcodes on the circulating items and library cards, located on the cradle. Another circulating item receiving area is formed by a video slot and is used to receive video cases. The terminal, moreover, comprises a keyboard, a magnetic strip read, a printer, a proximity sensor, and an acoustic transducer. Further, a cash slot can be integrated into the housing. The receiving surface for the item is as large as the largest item to be checked.

European Pat. Application No. EP 0 372 716, which corresponds to U.S. Pat. No. 4,881,061, discloses a system for monitoring the removal of specially marked items from a facility by a specially authorized user. An example is a circulating surveillance system for libraries. A terminal of the facility comprises, apart from the AIC system (article inventory control), an electronic article surveillance (EAS) system. A component attached to the housing serves to measure the characteristic of the item, such as, for example, the thickness of a book.

U.S. Publication No. 2001/0038037 A1 describes a cash register system with a portable, hand-held optical reader in a housing for reading encoded information on articles, which is separate from the keyboard housing, however.

German Utility Pat. No. DE 91 15 209 U1 relates to a keyboard for connection to a computer with detachable keyboard blocks or modules, which are connectable and optionally can be combined with one other. The detachable connection is enabled by plug connections or detachable cable connections.

### SUMMARY OF THE INVENTION

It is therefore an object of the present invention to provide the further development of a keyboard such that in addition to the manual, i.e., keyboard-bound input, data input wirelessly or optically of data stored on ID cards or access cards is also made possible, whereby the input occurs rapidly, reliably, and securely.

The present invention relates to a keyboard as a peripheral device for a computer unit with a key field and an associated housing, whereby an extension is attached to the housing. The key field is, for example, a numeric and/or an alpha and/or an alphanumeric key field, which comprises from 14 to 105 keys, whereby the keyboard layout, if this is a keyboard for German-speaking users, is specified in DIN 2137. The invention is not limited with respect to the housing: It can be, for example, a substantially rectangular, flat structure with a top side rising slightly toward the back, in other words, away from the operator, said structure in which the key field is arranged. For ergonomic considerations, a design slightly modified therefrom may be selected; for example, the housing has two housing sections arranged angled to one another and also curved, each with an associated key field provided for the left and/or right hand. The housing can be made of, for example, plastic. The extension also has, for example, a housing of plastic. Keyboard housings and extensions may be designed as a single part or having multiple parts. At least one reading device is arranged in the extension according to the invention, said reader which is suitable for contactless reading (therefore for the contactless machine reading in contrast to reading off) of data stored on ID cards or access cards. The terms reading device and ID card and/or access card are to be interpreted broadly. In the case of the reading device, the only issue is that the reading occurs in a contactless manner; in other words, an arrangement near the extension and near the keyboard, optionally in combination with a suitable orientation of the card, is sufficient to read the data located thereon.

The ID card may be, for example, a personal ID, particularly a passport, a driver's license, an airline ticket, a credit card, or some other card-shaped personal carrier of data that can be read without contact. By the contactless reading, the card can be examined further and the additional data printed thereon, such as name and ID number, birth date, address, etc., can be easily read off and provided simply optionally simultaneously with the reading process by the reading device and entered with the keyboard. Due to the arrangement of the reading device near the keyboard, the card is also near the keyboard and the respective operator, which is of advantage for data protection considerations. Due to the arrangement of the reading device in an extension attached to the keyboard, a space-saving and relatively interference-free solution is created for the arrangement of both.

The reading device operating in a contactless manner is preferably an optical reading device, preferably a 2D scanner (depending on the employed optical encoding of the data with a CCD or photodiode cell) for data optically encoded on the ID card or access card and/or a wireless reading device for the reading of data stored in a radio transponder on the ID card or access card. For example, the wireless reading device is designed for the reading of RFID transponders. In a particular embodiment, both aforementioned contactless reading devices are accommodated in the extension, which is also described as a lectern-like structure. Apart from these contactless reading devices, other card reading devices can be provided in the keyboard or at the projection: For example, a magnetic strip reader is integrated into the keyboard. The 2D scanner and the wireless reading device are preferably used, because in the technology employed thereby no relative movement between the reading device and card is necessary, which makes the reading of the data not prone to interference.

In an embodiment, the reading device and the keyboard can be connected via a common communication connection to a computer unit. The communication connection can occur via a common cable, for example, with a USB connection, or over a wireless connection, for example, by means of Bluetooth®. As a result, the structural cost required for the communication with both devices and a computer unit is reduced.

To make the reading off of the data printed on the card easier, the lectern-like structure can be arranged on the side of the keyboard housing facing away from the keyboard operator. In other words, from the operator's viewpoint, the lectern-like structure is located behind the key field, at the narrow back of the keyboard housing. Preferably, the lectern-like structure is arranged in the middle of said side.

The lectern-like structure rises substantially above the plane defined by the key field. Thus, with the aid of lectern-like structure, the orientation of the card by the operator and therewith the reading off thereof are made easier before the card, or the document can be placed in the molded area between the keyboard housing and the lectern-like structure, virtually upright and leaning against said structure.

The lectern-like structure can be designed in such a way and the reading device accommodated therein arranged so that an optical encoding of the card or document, arranged on or above the housing of the keyboard and between lectern-like structure and key field, and/or a radio transponder of the card arranged therein can be read. In an embodiment, the automatic reading of the data occurs one after another, because for access by the RFID system to the data integrated in the processor prior detection of the data by the reader is necessary, and this occurs while the cards or the document (personal ID cards, passport, etc.) are placed in the unit by the user.

The extension can be designed like a lectern, whereby, for example, in the uppermost, lectern-top-like part of the extension an optical 2D scanner is arranged, whose field of view is directed downward in the direction of keyboard.

The extension can be positioned pivotably and/or slidably relative to the housing of the keyboard. As a result, the orientation of the extension or its position can be adjusted according to the desired orientation of the card and/or document to be read. In an embodiment, the extension on the housing is so pivotable that as a result the overall height of the keyboard of the invention perpendicular to the key field level is minimized, which simplifies storage and transport of the keyboard.

In another embodiment, the extension can be separated and attached again to the housing of the keyboard, which also facilitates storage and transport.

The invention relates further to a computer unit with a keyboard of the invention in one of the previously described embodiments. The computer unit together with a computer program product carried out thereon is used for decoding and evaluating the data obtained by means of the reading device.

The keyboard of the invention is used, for example, for data input at a rental agency, for leasing, at insurance companies, in the hotel and catering industry, for payment confirmation, registrations and deregistrations at agencies, during ID checks at borders, and during check-ins at airports.

The invention relates further to a use of the previously described keyboard for the contactless reading, preferably optical reading and/or wireless reading of data stored on access or ID cards. The optical encoding is preferably carried out according to one of the following standards or methods: 1D code, such as EAN, UPC, IAN, JAN, 2/5 interleaved, code 39, code 93, code 128, 2D stacked code, such as Codablock, PDF 417, 2D matrix code, such as QR code, DataMatrix, MaxiCode, AztecCode, and Dotcode.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic, perspective view of the keyboard 1 of the invention with an ID card 6 placed thereon; and

FIG. 2 shows several optical data codes by way of example, which can be used, inter alia, on ID card 6.

### DETAILED DESCRIPTION

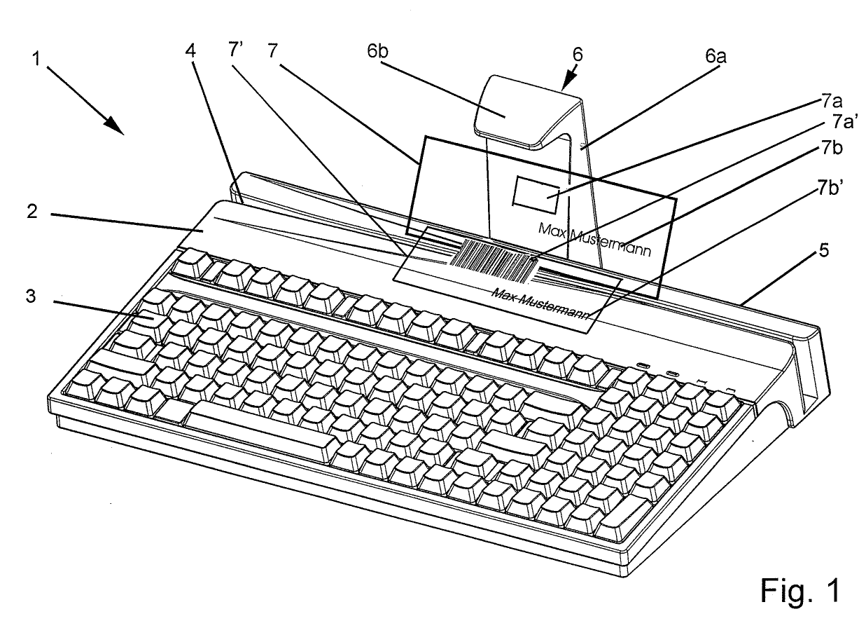

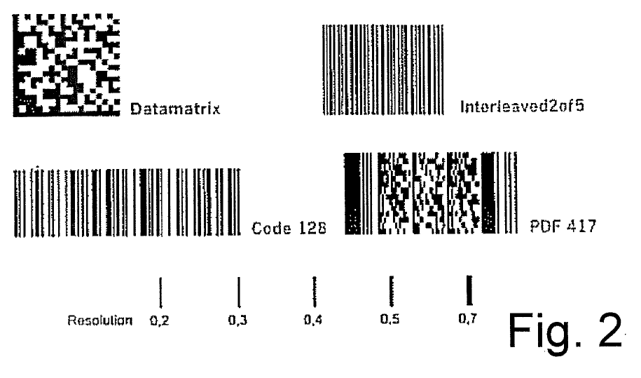

FIG. 1 shows an embodiment of keyboard 1 of the invention. Keyboard 1 has a flat, rectangular housing 2 with a sloping top side, in which a key field 3 is embedded. From the viewpoint of the operator of keyboard 1, behind key field 3 there is a slot 4 of a magnetic strip reader (not shown in greater detail), which is used for the reading in of data stored on a magnetic strip of an ID card, by sliding the card in the appropriate direction through slot 4 provided for the magnetic card reader. An extension 6, which rises lectern-like and is slidable at least in sections along aforementioned narrow side 5, is attached to keyboard 1 on narrow side 5 facing away from the operator. Extension 6 has a vertical columnar section 6a and a lectern-top-shaped hood 6b. The vertical columnar section 6a can be used to accommodate a wireless reading device for the reading of data stored in a radio transponder, for example, in RFID technology (not shown). A 2D Scanner is accommodated in hood 6b, said scanner whose detection field or field of vision is directed downward onto the region between narrow side 5 and key field 3. An ID card 6 can be placed in the region so that it is supported downward, on the one hand, in the bottom of area extension 6a and in the extension of housing 5 and, on the other, leans against the columnar section 6a of projection 6. The data 7a′ and 7b′ on ID card 7′ are read by the 2D scanner, which is disposed in the 6b region, whereby card 7′ or the document is located parallel over region 2. The positioning of card 7′ can occur using the 2D scanner laser beam detectable by the eye. The read out data are optionally read and evaluated with use of a computer unit, connected to the scanner, and a computer program product. In the shown placement of card 7, data stored on an RFID chip 7a are detected. FIG. 2 shows several optical data codes by way of example, which can be used, inter alia, on ID card 7 or a document. The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A keyboard as a peripheral device for a computer unit, the keyboard comprising:
a key field;
an associated housing;
an extension configured to be attached to the housing; and
at least one reading device accommodated in the extension for the contactless reading of data stored on an ID card, a document, or an access card.

2. The keyboard according to claim 1, wherein the extension is formed lectern-shaped.

3. The keyboard according to claim 1, wherein the extension has a vertical columnar section and a lectern-top-shaped hood so that the vertical columnar section and the lectern-top-shaped hood are used to accommodate the at least one reading device for the contactless reading of the data.

4. The keyboard according to claim 1, wherein the reading device is an optical reading device or a 2D scanner for the reading of optically encoded data on the ID card, document, or access card and/or a wireless reading device for the reading of data stored in a radio transponder of the ID card or access card.

5. The keyboard according to claim 4, wherein the vertical columnar section is used to accommodate the radio transponder.

6. The keyboard according to claim 1, wherein the projection is arranged on a side of the keyboard housing facing away from a keyboard operator.

7. The keyboard according to claim 1, wherein the extension rises substantially above the plane defined by the key field.

8. The keyboard according to claim 1, wherein the extension is such that the placement of the card or document in the molded area between the keyboard housing and the lectern-top-shaped hood occurs in a virtually upright and leaning manner.

9. The keyboard according to claim 1, wherein the extension is positioned pivotably and/or slidably relative to the housing of the keyboard.

10. The keyboard according to claim 1, wherein the extension is attached separably and reattachably to the housing of the keyboard.

11. The keyboard according to claim 2, wherein the projection with the lectern-top-like structure is arranged fixedly and/or flexibly facing away from an operator.

12. A computer unit having a keyboard, the keyboard comprising:
a key field;
an associated housing;
an extension configured to be attached to the housing; and
at least one reading device accommodated in the extension for the contactless reading of data stored on an ID card, a document, or an access card.

13. The keyboard according to claim 1, wherein the keyboard facilitates the optical reading and/or wireless reading of data stored on access or ID cards or documents.

14. The keyboard according to claim 13, wherein the cards or the document is an ID card, a personal ID card, a passport, a driver's license, an airline ticket, a credit card, or another card-shaped, personal carrier of data is readable without contact.

15. The keyboard according to claim 1, wherein the keyboard is for data input at a rental agency, for leasing, at insurance companies, in the hotel and catering industry, for payment confirmation, registrations and deregistrations at agencies, during ID checks at borders, and during check-ins at airports.
